(19) United States
(12) Patent Application Publication
(10) Pub. No.: US 2013/0173071 A1
(43) Pub. Date: Jul. 4, 2013

(54) ENERGY MANAGEMENT SYSTEM AND CONTROL METHOD THEREOF

(71) Applicant: Samsung Electronics Co., Ltd., Suwon-si (KR)

(72) Inventors: Gye Young LEE, Seoul (KR); Sung Hoon KIM, Seoul (KR); Du San BAEK, Seoul (KR)

(73) Assignee: Samsung Electronics Co., Ltd., Suwon-si (KR)

(21) Appl. No.: 13/733,460

(22) Filed: Jan. 3, 2013

(30) Foreign Application Priority Data
Jan. 4, 2012 (KR) 10-2012-0001023

(51) Int. Cl. G05B 13/02

(52) U.S. Cl. CPC G05B 13/02
USPC 700/286

(57) ABSTRACT

An energy management system and a control method thereof reduces traffic load between the energy management system and display devices by transmitting changes in states of a plurality of home appliances to the display devices in a bundle form, upon occurrence of an event to control an energy level according to variation in electricity price.

### CROSS-REFERENCE TO RELATED APPLICATIONS

This application claims the priority benefit of Korean Patent Application No. 10-2012-0001023, filed on Jan. 4, 2012 in the Korean Intellectual Property Office, the disclosure of which is incorporated herein by reference.

### BACKGROUND

1. Field

The following description relates to an energy management system to display changes in operation states of home appliances, and a control method thereof.

2. Description of the Related Art

An intelligent power network refers to a power network of a new concept to optimize energy efficiency by real-time bidirectional exchange of information between a utility company and a customer through incorporation of information communication technology into a unidirectional power supply architecture of electricity generation, transmission, distribution, and sale.

The intelligent power network includes a utility company, an Energy Management System (EMS), and a smart home appliance, which is a power consuming device. When necessary, a simpler configuration or more complicated configuration may be proposed by combining the above elements or adding other elements.

The EMS sets and controls energy usage of each home appliance and monitors the operation state of each home appliance.

The EMS controls a variety of display devices, such as a TV, a smartphone, and a PC, connected thereto to display a change in the state of each home appliance.

According to a conventional system, a utility company or an electricity price server transmits an energy level event to control an energy level according to variation in electricity price to the EMS in order to manage load. Upon receiving the energy level event, the EMS changes the performance of each home appliance by changing an energy level of each home appliance to another level. That is, the EMS controls the operation of each home appliance such that each home appliance may operate within the range of the amount of allowable energy. In this case, the EMS receives a change in the state of each home appliance and controls display devices such as a TV, a smartphone, and a PC to display the change in the state of each home appliance on the display devices.

However, a process of receiving a change in the state of each home appliance according to an energy level event and displaying the change in the state of each home appliance on each display device applies excessive traffic load to the EMS as the number of home appliances and display devices increase.

For example, if the state of an air conditioner is changed according to a change in an energy level, the EMS transmits information about a change in the state of the air conditioner to each display device. Moreover, if the state of a refrigerator is changed according to a change in energy level, the EMS transmits information about a change in the state of the refrigerator to each display device. Furthermore, if the state of a washing machine is changed according to a change in an energy level, the EMS transmits information about a change in the state of the washing machine to each display device. In each case, a separate data packet is transmitted for each change of state of each respective home appliance to each respective display device.

For example, if a system includes 10 home appliances and 4 display units, and each appliance changes state, 40 data transmission flows are temporarily generated between the EMS and the respective display devices, thereby causing an excessive traffic load.

If the traffic load between the EMS and the display devices increases or this traffic load exceeds a level which may be handled by the EMS, data transmission may be delayed or, in a severe case, a change in the state of each home appliance may not be displayed on the display devices.

Processing of such excessive traffic load requires a high performance EMS, thereby resulting in an increase in manufacturing costs.

### SUMMARY

Therefore, it is an aspect of the following description to provide an EMS to reduce traffic load by transmitting changes in states of a plurality of home appliances in a bundle form upon occurrence of an event to control an energy level according to variation in electricity price, and a control method thereof.

Additional aspects of the invention will be set forth in part in the description which follows and, in part, will be obvious from the description, or may be learned by practice of the invention.

In accordance with one aspect, an energy management system includes a communication unit to communicate with a plurality of display devices, a storage unit to store state change information of a plurality of home appliances, and a controller to change energy levels of the plurality of home appliances, receive state change information according to changes in the energy levels of the plurality of home appliances, store the received state change information in the storage unit, and transmit the state change information of the plurality of home appliances stored in the storage unit to the plurality of display devices through the communication unit in a bundle form.

The controller may change the energy levels of the plurality of home appliances according to energy level information upon receiving the energy level information from a server through the communication unit.

The controller may collect the state change information of the home appliances stored before a predetermined time has elapsed after the energy levels of the plurality of home appliances are changed and transmit the collected state change information to the plurality of display devices in a bundle form.

The controller may generate bundle data including one header and a plurality of pieces of state change data with respect to the state change information of the home appliances stored before a predetermined time has elapsed after the energy levels of the plurality of home appliances are changed and sequentially transmit the generated bundle data to the plurality of display devices.

The storage unit may include a buffer including a plurality of divided memory areas and store state change information of a corresponding home appliance in a corresponding memory area.

In accordance with an aspect, a method to control an energy management system which displays state change information of a plurality of home appliances on a plurality of display devices includes changing energy levels of the plurality of home appliances, receiving and storing the state change information of the plurality of home appliances according to changes in the energy levels of the plurality of home appliances, and transmitting the stored state change information of the plurality of home appliances to the plurality of display devices in a bundle form.

The changing the energy levels may include determining whether energy level information is received from a server and, if the energy level information is received, changing the energy levels of the plurality of home appliances according to the received energy level information.

The transmitting the stored state change information may include collecting the state change information of the home appliances stored before a predetermined time has elapsed after the energy levels of the plurality of home appliances are changed and transmitting the collected state change information to the plurality of display devices in a bundle form.

The transmitting the stored state change information may include generating bundle data including one header and a plurality of pieces of state change data with respect to the state change information of the home appliances stored before a predetermined time has elapsed after the energy levels of the plurality of home appliances are changed and sequentially transmitting the generated bundle data to the plurality of display devices.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a diagram illustrating the configuration of an intelligent power network to which an EMS is applied according to an exemplary embodiment;

FIG. 2 is a diagram illustrating an example of a detailed operation in which an EMS transmits information about a change in the state of each home appliance to each display device according to an exemplary embodiment;

FIG. 3 is a block diagram of an EMS according to an exemplary embodiment;

FIG. 4 is a diagram illustrating storage of state change information of each home appliance in a buffer of an EMS according to an exemplary embodiment;

FIG. 5 is a diagram explaining bundle data transmitted to each display device from an EMS according to an exemplary embodiment;

FIG. 6 is a diagram explaining an example of bundle data transmitted to each display device from an EMS according to an exemplary embodiment;

FIG. 7 is a diagram explaining an example of bundle data transmitted to each display device from an EMS according to an exemplary embodiment; and

FIG. 8A and FIG. 8B are flowcharts illustrating control operation of an EMS according to an exemplary embodiment.

### DETAILED DESCRIPTION

Reference will now be made in detail to the embodiments of the present invention, examples of which are illustrated in the accompanying drawings, wherein like reference numerals refer to like elements throughout.

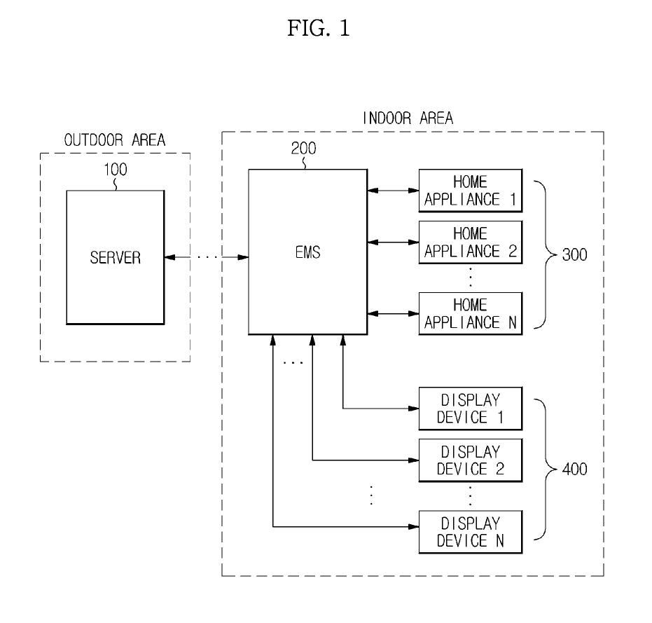

FIG. 1 illustrates the configuration of an intelligent power network to which an EMS is applied according to an exemplary embodiment.

As illustrated in FIG. 1, the intelligent power network includes an outdoor server 100, an indoor EMS 200, a plurality of home appliances 300, which are power consuming devices, and a plurality of display devices 400. In some cases, a simpler configuration or a more complicated configuration may be proposed as the intelligent power network by combining the above elements or adding other elements to the above elements.

The server 100 may be a server of a utility company or a server that provides electricity prices. The server 100 transmits energy level information according to a variation in electricity price to the EMS 200 so that the EMS 200 may control energy levels of the home appliances 300.

While the utility company produces a certain amount of electricity every hour to supply electricity to the home appliances 300, power consumed in a household greatly varies according to season and time. For example, generally, less power is consumed at dawn or in the morning than in the afternoon or evening, and less power is consumed in spring and fall than in summer and winter.

Upon supplying power to the home appliances, the utility company sets a low price on power consumed at a time during which power consumption is low relative to power consumed at a time during which power consumption is high, and sets a low price on power consumed in seasons during which power consumption is low relative to power consumed in seasons during which power consumption is high.

The server 100 may dynamically set electricity prices according to power dissipation of the home appliances 300 to supply power to the home appliances 300, thereby balancing the supply and consumption of power.

For example, the server 100 predicts the amount of power consumption, based on the amount of power production, information about past power usage per season and time, and weather forecast information and determines an electricity price. The server 100 determines an energy level corresponding to the electricity price and, when energy management is needed, transmits an energy level event including energy level information to the indoor EMS 200.

The server 100 collects and stores the amount of power consumed in the home appliances 300 per electricity price level for the utility company to calculate a monthly electricity price according to the amount of power consumption per electricity price level and to charge a customer an electricity price.

The server 100 determines power supply limitation by comparing periodically calculated electricity prices with a predetermined monthly permissible electricity price. If the calculated electricity price exceeds the monthly permissible electricity price, the server 100 transmits an energy level event including information about an energy level to be changed to the EMS 200 so that the EMS 200 may generate the energy level event.

In this way, the server 100 transmits the energy level information to the EMS 200 to cause the EMS 200 to manage the energy demand of the home appliances 300.

The server 100 transmits and receives information for energy demand management to and from the indoor EMS 200 through a network which may be a wired network, a wireless network, or a wired/wireless composite network.

The EMS 200 may be a Demand Response (DR) controller. The EMS 200 sets and controls energy usage of the home appliances 300 and monitors the operation states of the home appliances 300.

Upon receiving the energy level event from the server 100, the EMS 200 generates the energy level event. If the energy level event is generated, the EMS 200 receives changes in the states of the home appliances 300 from the home appliances 300, and transmits the changes in the states of the home appliances 300 to the display devices 400 in a bundle form to display the changes in the states of the home appliances 300 on the display devices 400.

The home appliances 300, which are power consuming devices used in a household, may include an air conditioner, a refrigerator, or a washing machine, for example.

The display devices 400 display the changes in the states of the home appliances 300. The display devices 400 are connected to the EMS 200 through a network by wire or wirelessly, and transmit and receive information. The display devices may include a TV, a smartphone, or a PC, for example.

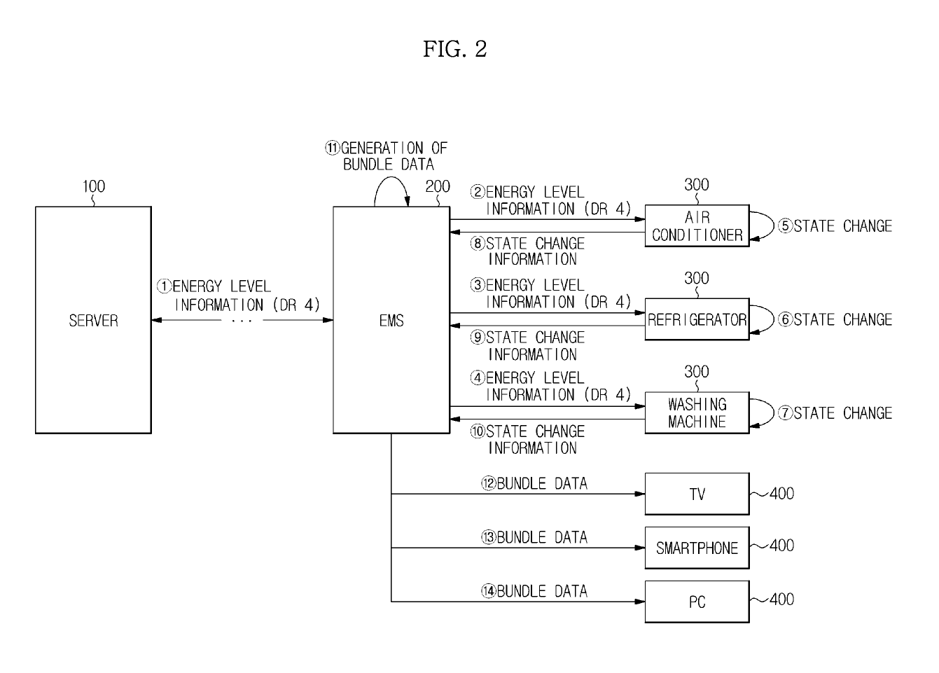

FIG. 2 illustrates an example of a detailed operation in which an EMS transmits information about a change in the state of each home appliance to each display device according to an exemplary embodiment.

As illustrated in FIG. 2, the server 100 transmits energy level information (e.g. DR 4) to the EMS 200 together with an energy level event so that the EMS 200 may control the energy level of each home appliance 300 according to variation in electricity price.

The energy level information may be a target energy level to change the energy level of each home appliance 300. The energy level is divided into DR 1 to DR 4 based on energy usage of each home appliance 300. DR 1 is an energy level at which the home appliance 300 may normally operate without restricting energy usage of the home appliance 300. Energy usage of the home appliance 300 is increasingly restricted from DR 2 up to DR 4, such that DR4 is an energy level at which the energy usage of the home appliance 300 is most restricted.

Upon receiving the energy level event, the EMS 200 sequentially transmits energy level information received from the server 100 to the home appliances 300, such as an air conditioner, a refrigerator, and a washing machine, for example.

Upon receiving the energy level information, the air conditioner, the refrigerator, and the washing machine change operation states thereof according to the energy level information.

For example, upon receiving the energy level information of DR 4 from the EMS 200, the washing machine 300 performs operations corresponding to DR 4 by changing hydration speed from high speed hydration to low speed hydration or turning off a display panel, and the refrigerator 300 performs operations corresponding to DR 4 by lowering a freezing temperature or turning off a display panel.

The air conditioner, refrigerator, and washing machine transmit state change information to the EMS 200 according to changes in the states thereof. The state change information includes information about changes in the operation states of the home appliances 300 and changes in operation completion times of the home appliances 300, according to the energy level information received from the EMS 200.

The EMS 200 stores the state change information of the air conditioner, refrigerator, and washing machine received in a prescribed time in a buffer and generates bundle data displayable on the display devices 400 using the state change information. The bundle data includes the state change information of the air conditioner, refrigerator, and washing machine received within a predetermined time.

The EMS 200 sequentially transmits the bundle data to the display devices 400, for example, a TV, a smartphone, and a PC.

Thus, when an energy level event to control an energy level according to variation in electricity price is generated, because the EMS 200 transmits changes in the states of the home appliances 300 to the display devices 400 as bundle data, a traffic load between the EMS 200 and the display devices 400 may be reduced. The traffic load may be processed without the necessity of high performance of the EMS, and thus, manufacturing costs may be reduced.

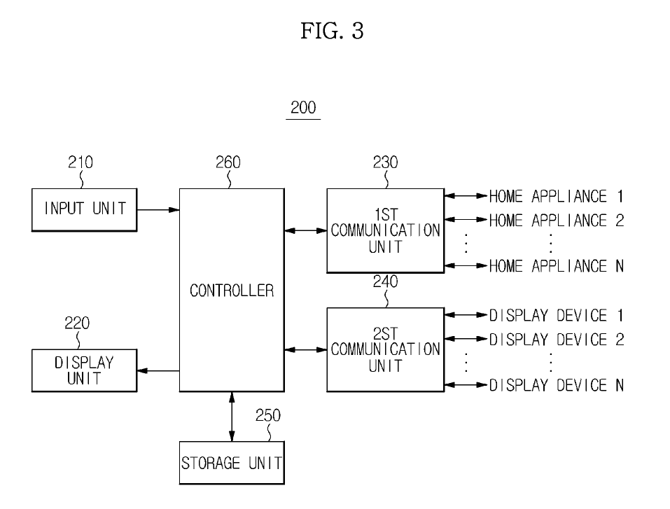

FIG. 3 illustrates an EMS according to an exemplary embodiment.

As illustrated in FIG. 3, the EMS 200 includes an input unit 210, a display unit 220, a first communication unit 230, a second communication unit 240, a storage unit 250, and a controller 260.

The input unit 210 receives information input by a user. The display unit 200 displays information to be transmitted to a user on a screen. The input unit 210 and the display unit 220 may constitute a touchscreen.

In this case, the input unit 210 includes a touch panel to sense a user touch. The input unit 210 recognizes a touch position of a touch signal sensed through the touch panel, a moving direction of the touch signals, and the number of touch operations, and transmits the touch information to the controller 260. The touch panel of the input unit 210 may sense a signal indicating a touch point. The touch panel is implemented by a transparent panel having a touch sensitive surface and is mounted on a visible surface, for example, an LCD of the display unit 220 to form the touchscreen.

The display unit 220 includes an LCD. The display unit 220 converts a data signal provided from the controller 260 into an image signal displayable on the LCD and displays the image signal on the LCD. In addition to the LCD, a Plasma Display Panel (PDP) or an Organic Light Emitting Diode (OLED), for example, may be used as the display unit 220.

The first communication unit 230 performs communication with the server 100 or the home appliances 300.

The second communication unit 240 performs communication with the display devices 400. While the first and second communication units 230 and 240 are separately explained for convenience of description, the present disclosure is not limited thereto and only one communication unit may be used when necessary.

The storage unit 250 stores state change information of the home appliances 300 received from the home appliances 300. The storage unit 250 includes a buffer having a plurality of divided memory areas and stores the state change information of the home appliances 300 received from the home appliances 300 in corresponding memory areas.

The controller 260 sequentially transmits energy level information to the home appliances 300 through the first communication unit 230 upon occurrence of an event. Each home appliance 300 changes a current energy level to another energy level according to the received energy level information for operation thereof, and transmits state change information indicating state change according to variation in energy level.

The controller 260 receives the state change information from the home appliances 300 and controls the storage unit 250 to store the state change information.

If a predetermined time has elapsed after the occurrence of an event or if a predetermined time has elapsed after the energy level of each home appliance is changed, the controller 260 transmits the state change information of each home appliance stored in the storage unit 250 to each display device 400 through the second communication unit 240 as bundle data. To this end, upon lapse of a predetermined time after the occurrence of an event, the controller 260 binds one header and the state change information of the respective home appliances together and generates bundle data consisting of a data packet including one header and a variety of pieces of state change information. The controller 260 sequentially transmits the state change information of the home appliances 300 to the display devices 400 as bundle data.

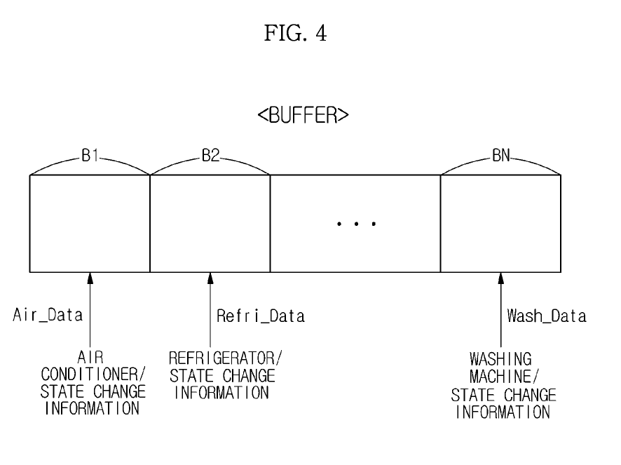

FIG. 4 illustrates storage of state change information of each home appliance in a buffer of an EMS according to an exemplary embodiment.

As illustrated in FIG. 4, the storage unit 250 of the EMS 200 stores the state change information of the home appliances 300.

The buffer of the storage unit 250 includes a plurality of divided memory areas B1 to BN.

Each memory area is assigned to each home appliance and state change information of a corresponding home appliance is stored in a corresponding memory area. The controller 260 receives the state change information of a corresponding home appliance and controls the storage unit 250 to store the state change information of each home appliance in the buffer thereof.

For example, state change information Air_Data of the air conditioner is stored in a first memory area B1 of the buffer. State change information Refri_Data of the refrigerator is stored in a second memory area B2 of the buffer. In this way, state change information Wash_Data of the washing machine is stored in a last memory area BN of the buffer.

If a predetermined time (e.g. one second) has elapsed after occurrence of an event, the controller 260 generates bundle data using the state change information of the home appliances stored in the memory areas B1 to BN and transmits the bundle data to the display devices 300, which will be described later.

After generating the bundle data or transmitting the generated bundle data, the controller 260 deletes the state change information of the respective home appliance stored in the respective memory regions B1 to BN in order to generate next bundle data.

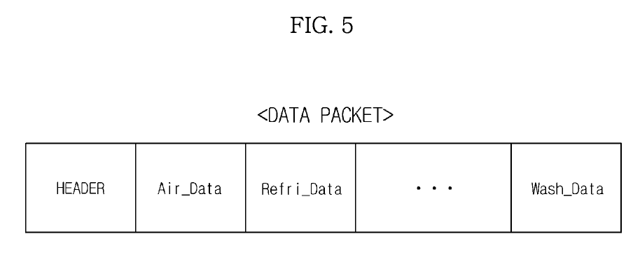

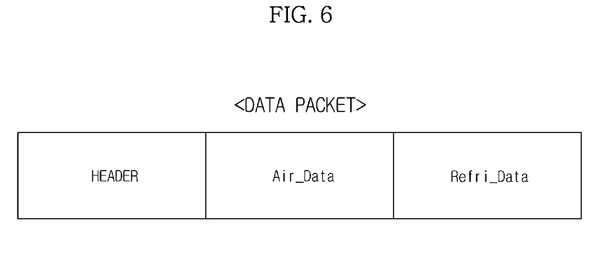

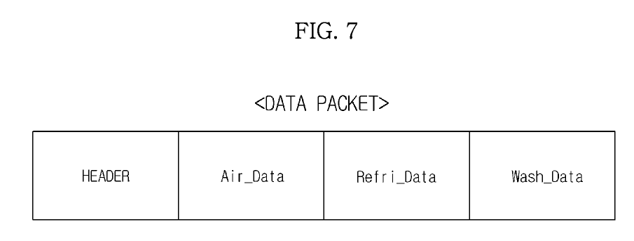

FIG. 5 explains bundle data transmitted to each display device from an EMS according to an exemplary embodiment. FIG. 6 illustrates an example of bundle data transmitted to each display device from an EMS according to an exemplary embodiment. FIG. 7 illustrates an example of bundle data transmitted to each display device from an EMS according to an exemplary embodiment.

As illustrated in FIG. 5, a data packet of bundle data includes one header and state change information Air_Data, Refri_Data, . . . , Wash_Data. Although the data packet includes a plurality of pieces of state change information in a data section, the data packet includes only one header in a header section. Accordingly, when the bundle data is transmitted to the display devices 400, the overall amount of data may be reduced. Then, traffic load between the EMS 200 and each display device 200 is decreased and the entire amount of data transmission is reduced. As a result, a response time is shortened and information update speed in each display device 400 may be improved.

The data section of the data packet of the bundle data includes the state change information of the home appliances which is stored for a predetermined time in the buffer of the storage unit 260 and thus does not include state change information of the home appliances which is not stored in the buffer before the predetermined time has elapsed.

As illustrated in FIG. 6, the data section of the data packet of the bundle data may include state change information of two home appliances, i.e. state change information Air_Data of the air conditioner and state change information Refri_Data of the refrigerator.

Further, as illustrated in FIG. 7, the data section of the data packet of the bundle data may include state change information of three home appliances, i.e. state change information Air_Data of the air conditioner, state change information Refri_Data of the refrigerator, and state change information Wash_Data of the washing machine.

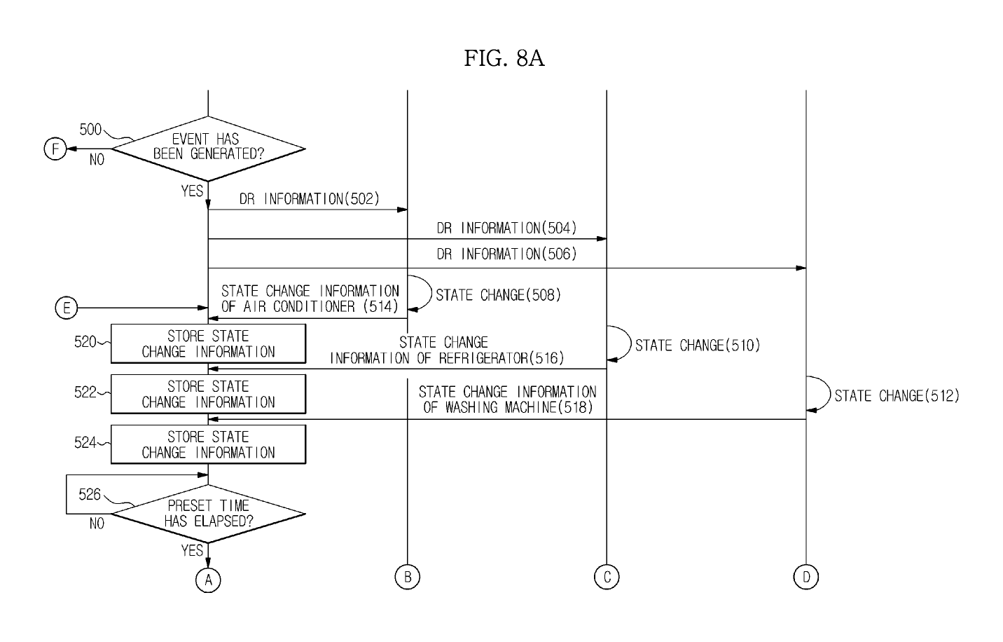

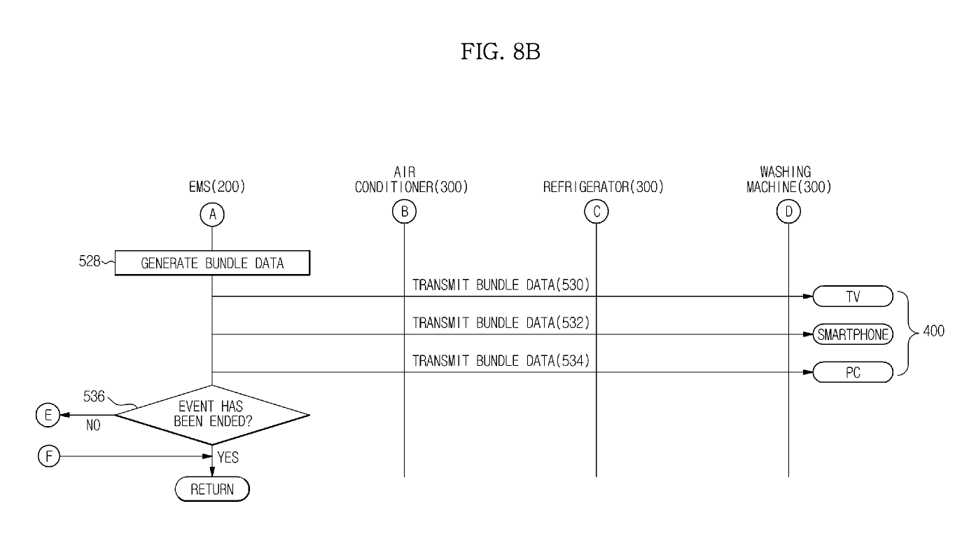

FIG. 8A and FIG. 8B illustrate control operation of an EMS according to an exemplary embodiment.

Referring to FIG. 8A and FIG. 8B, the EMS 200 determines whether an event to control an energy level according to variation in electricity price has been generated (operation 500).

If no event has been generated in operation 500, the procedure returns to a normal mode rather than an energy level control mode. In the normal mode, a data packet of state change information of a corresponding home appliance among state change information of the home appliances 300, for example, an air conditioner, a refrigerator, and a washing machine is sequentially transmitted to the display devices 400, for example, a TV, a smartphone, and a PC in order of reception in the EMS 200. That is, whenever state change information of each home appliance is received, the EMS 200 transmits a data packet of the state change information to each display device 400.

Meanwhile, if the event has been generated, the EMS 200 transmits DR information to home appliances, for example, an air conditioner 300, a refrigerator 300, and a washing machine 300 (operations 502, 504, and 506). Whether the event has been generated may be determined according to whether DR information has been received from the server 100. Namely, if the DR information has been received, it is determined that the event has been generated and, if not, it is determined that the event has not been generated.

Upon receiving the DR information, the air conditioner 300, the refrigerator 300, and the washing machine 300 change operation states thereof by changing current energy levels (operations 508, 510, and 512). For example, if an energy level received from the EMS 200 is DR 4, the refrigerator 300 performs operations corresponding to DR 4 by lowering a freezing temperature or turning off a display panel, and the washing machine 300 performs operations corresponding to DR 4 by changing hydration speed from high speed hydration to low speed hydration or turning off a display panel.

After changing operation states, the air conditioner 300, the refrigerator 300, and the washing machine 300 transmit state change information to the EMS 200 (operations 514, 516, and 518). The state change information according to changes in the states of the air conditioner, the refrigerator, and the washing machine may include information about changes in operation states and changes in operation completion times as the air conditioner, the refrigerator, and the washing machine operate by changing an energy level according to the DR information.

The EMS 200 receives the state change information of the air conditioner 300, the refrigerator 300, and the washing machine 300 from the air conditioner 300, the refrigerator 300, and the washing machine 300, respectively, and stores the state change information in corresponding memory areas of the buffer of the storage unit 250 (operations 520, 522, and 524).

Next, the EMS 200 determines whether a predetermined time has elapsed (operation 526). The predetermined time is a prescribed time (e.g. one second) after the event has been generated and may indicate a period to transmit the state change information of the home appliances stored in the buffer of the storage unit 250 as bundle data. That is, the predetermined time is a time to transmit only state change information of corresponding home appliances collected for one second.

If the predetermined time has elapsed in operation 526, the EMS 200 generates bundle data using the state change information of the home appliances stored in the buffer of the storage unit 250 (operation 528). The EMS 200 sequentially transmits the bundle data to a TV, a smartphone, and a PC (operations 530, 532, and 534).

After transmitting the bundle data, the EMS 200 determines whether the event has been ended (operation 536). If the event has been ended in operation 536, the EMS 200 returns to a predetermined routine, i.e. an algorithm for normal mode operation. Meanwhile, if the event has been not ended, the EMS proceeds to an operation mode before receiving the state change information from the home appliances 300.

According to the present disclosure, traffic load between an EMS and each display device may be reduced by transmitting changes in the states of a plurality of home appliances in a bundle form upon occurrence of an event to control an energy level according to variation in electricity price.

According to the present disclosure, because traffic load between an EMS and each display device may be reduced by transmitting changes in the states of a plurality of home appliances in a bundle form, traffic load may be processed without the necessity of a high performance EMS, thereby reducing manufacturing costs.

According to the present disclosure, because the amount of data transmission may be reduced by transmitting changes in the states of a plurality of home appliances in a bundle form, a response time is shortened and thus information update speed of each display device may be improved.

As is apparent from the above description, because changes in the states of the plurality of home appliances are transmitted to each display device in a bundle form upon the occurrence of an event to control an energy level according to variation in electricity price, traffic load between the EMS and each display device may be reduced. Then, because traffic load may be processed without the necessity of a high performance EMS, manufacturing costs may be reduced.

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An energy management system comprising:
a communication unit to communicate with a plurality of display devices;
a storage unit to store state change information of a plurality of home appliances; and
a controller to change energy levels of the plurality of home appliances, receive state change information according to changes in the energy levels of the plurality of home appliances, store the received state change information in the storage unit, and transmit the state change information of the plurality of home appliances stored in the storage unit to the plurality of display devices through the communication unit in a bundle form.

2. The energy management system according to claim 1, wherein the controller changes the energy levels of the plurality of home appliances according to energy level information upon receiving the energy level information from a server through the communication unit.

3. The energy management system according to claim 1, wherein the controller collects the state change information of the home appliances stored before a predetermined time has elapsed after the energy levels of the plurality of home appliances are changed and transmits the collected state change information to the plurality of display devices in a bundle form.

4. The energy management system according to claim 3, wherein the controller generates bundle data comprising one header and a plurality of pieces of state change data with respect to the state change information of the home appliances stored before a predetermined time has elapsed after the energy levels of the plurality of home appliances are changed and sequentially transmits the generated bundle data to the plurality of display devices.

5. The energy management system according to claim 1, wherein the storage unit comprises a buffer comprising a plurality of divided memory areas and stores state change information of a corresponding home appliance in a corresponding memory area.

6. A method to control an energy management system which displays state change information of a plurality of home appliances on a plurality of display devices, the method comprising:
changing energy levels of the plurality of home appliances;
receiving and storing the state change information of the plurality of home appliances according to changes in the energy levels of the plurality of home appliances; and
transmitting the stored state change information of the plurality of home appliances to the plurality of display devices in a bundle form.

7. The method according to claim 6, wherein the changing the energy levels comprises determining whether energy level information is received from a server and, if the energy level information is received, changing the energy levels of the plurality of home appliances according to the received energy level information.

8. The method according to claim 7, wherein the transmitting the stored state change information comprises collecting the state change information of the home appliances stored before a predetermined time has elapsed after the energy levels of the plurality of home appliances are changed and transmitting the collected state change information to the plurality of display devices in a bundle form.

9. The method according to claim 8, wherein the transmitting the stored state change information comprises generating bundle data comprising one header and a plurality of pieces of state change data with respect to the state change information of the home appliances stored before a predetermined time has elapsed after the energy levels of the plurality of home appliances are changed and sequentially transmitting the generated bundle data to the plurality of display devices.

10. A non-transitory computer-readable recording medium storing a program to implement the method of claim 6.

11. A method to display state change information of a plurality of home appliances on a plurality of display devices, the method comprising:
generating an event;
changing the state of each of the plurality of home appliances based on the event;
sequentially receiving state change information from each of the plurality of home appliances; and
transmitting a data packet to each of the plurality of display devices, respectively,
wherein each of the data packets comprises state change information for the plurality of home appliances.

12. The method of claim 11, wherein the transmitting the data packets is delayed by a predetermined amount of time after the event generation.

13. The method of claim 11, wherein each of the data packets further comprises a buffer comprising a header and a plurality of divided memory areas, and each of the divided memory areas comprises the state change information for each of the plurality of home appliances, respectively.

14. A non-transitory computer-readable recording medium storing a program to implement the method of claim 11.
